(19) United States
(12) Patent Application Publication
(10) Pub. No.: US 2026/0080579 A1
(43) Pub. Date: Mar. 19, 2026

(54) SYSTEM AND METHOD FOR ORIENTATION DETECTION AND CONTEXTUAL DECODING OF VISUAL MARKERS

(71) Applicant: Careloom Health Care LLP, Chennai (IN)

(72) Inventor: Suresh Kumar SANTHANAKRISHNAN, Thanjavur (IN)

(21) Appl. No.: 19/334,155

(22) Filed: Sep. 19, 2025

(30) Foreign Application Priority Data
Sep. 19, 2024 (IN) 202441071019

(51) Int. Cl. G06T 11/00; G06T 7/73; G06V 20/20; G06V 20/90

(52) U.S. Cl. CPC G06T 11/00; G06T 7/74; G06V 20/20; G06V 20/90; G06T 2200/24; G06T 2207/30196; G06T 2207/30204

(57) ABSTRACT

The invention describes a real-time response capture system that uses image recognition technology to interpret markers based on their rotational orientation. The system includes four main components: a scanning device for capturing marker images, an orientation detection module that calculates rotation angles relative to a reference point, a decoding module that interprets the marker data considering its orientation to generate contextual outputs, and a data analysis module that processes these outputs into application-specific reports.

### CROSS-REFERENCE TO RELATED APPLICATION

This application claims the benefit or priority of Indian patent application no. 202441071019 filed Sep. 19, 2024, the contents of which is incorporated by reference in its entirety.

### FIELD OF INVENTION

The present invention relates generally to optical marker recognition in augmented reality systems. More particularly, it pertains to methods and systems for real-time orientation detection of markers, more particularly, augmented reality (AR) codes) and performing contextual decoding of the content based on the rotational angle of the optical marker relative to a reference axis.

### BACKGROUND

Augmented reality technology superimposes digital information, such as images, sounds, or data, onto the real world through devices like smartphones, tablets, or AR glasses. AR technology enhances user's perception and interaction with their environment by blending virtual elements with physical reality in real time. Optical markers, such as AR codes and QR codes, are used extensively to embed digital information within physical objects or mediums. AR codes, or QR codes directed to AR applications, can provide enhanced experiences when scanned by a suitable application, offering superimposition of virtual objects and interactions, including with access to web-based resources.

AR technology leverages cameras, sensors, and advanced algorithms to track and display contextual information, making it useful for various applications, including education, business intelligence, gaming and industrial training, among several others.

Conventional methods of the use of AR codes and QR codes has revolved around simple scanning and information retrieval, which normally requires a user to possess an electronic device such as smartphones, tablets, or other specialized hardware, and also rely on manual input.

While QR codes are used in existing systems for interactive applications such as identity verification, attendance tracking and survey feedback collection, these systems are device-dependent and do not support orientation or context-based interaction with QR codes. Indeed, even after scanning a QR code, users often still need to manually interact with their devices to complete the intended action, leading to inefficiencies, delays in data processing and potential errors.

The device-dependent nature of existing systems means that such systems often lack the capability to provide real-time interactivity, especially in environments where electronic devices are not readily available or feasible. This limitation reduces user engagement and hinders the collection of timely data by systems which do not inherently support real-time, device-free interaction or dynamic user response capture.

This dependency also limits the application of existing systems in environments where seamless and efficient interaction is critical and creates barriers for users who may not have access to devices, thus limiting scalability and increasing costs.

Technologies other than QR code and visual markers, such as Radio Frequency Identification (RFID) and Near Field Communication (NFC) have been used for enabling contactless identification and data capture in various use cases. However, these technologies have some inherent limitations. They require specialized hardware, including RFID tags, readers, and NFC-enabled devices, making them expensive to implement and maintain. While effective for identification, they have limited interactivity or real-time feedback, restricting their application in scenarios where dynamic or interactive responses are needed. Additionally, the setup and maintenance of RFID/NFC systems can be complex, requiring technical expertise and infrastructure that may not be feasible for all use cases.

Mobile applications have been developed to facilitate interaction, attendance tracking, and feedback collection, often relying on users to manually select options or input data. However, these solutions are heavily dependent on the user interface of the app, which can vary in usability and accessibility, and potentially leading to user errors or dissatisfaction. Additionally, existing mobile application-based systems are not automated or intuitive and require active participation from users, who must navigate the app and input data, which make this process time-consuming and prone to mistakes. Also, the use of mobile applications alone limits the usage to interaction with a digital interface, which typically requires users to have electronic devices, and excludes scenarios where device-free interaction is preferred or necessary.

Further, existing systems use a camera or scanner to capture QR codes, including in cases where the code may be arbitrarily rotated or tilted with respect to the camera's viewing axis. However, such existing systems typically focus on mere detection and decoding of the QR code or other marker without giving any particular meaning to the rotational angle or the optical marker's orientation around a reference. In many use cases, knowledge of the QR code or other marker's orientation can be highly valuable. For instance:
1. Alignment of Augmented Reality Content: If AR content is overlaid in a real-world scene, understanding the optical marker's orientation can help position or rotate virtual elements more accurately.
2. Directional Context: For certain applications (e.g., museum exhibits or interactive product packaging), orientation data can enable the system to correctly adapt the displayed content based on how the optical marker is oriented.

Orientation-aware decoding determined by the rotational angle of the optical marker can enrich user interaction, as the decoded output may change in real-time in response to the optical marker's orientation. For instance, the user interface may activate different features or advanced content depending on the tilt or orientation of the optical marker.

Existing solutions that involve advanced identification and interaction technologies can be complex to implement and maintain, often requiring significant investment in hardware, software, and training. These solutions each address some aspects of the problem statement but fall short in key areas such as accessibility, flexibility, cost-effectiveness, and real-time interaction and feedback. Despite multiple existing methods for detecting and decoding markers, there is a lack of specialized solutions that integrate orientation detection and contextual decoding into a combined, streamlined approach.

Therefore, there is a need for a system for real-time, dynamic response capture, identification and interaction that eliminates the above-mentioned reliance on electronic devices, specialized hardware, and other related limitations, while also supporting orientation or context-based interaction.

### SUMMARY

The invention provides an integrated system and method to detect and interpret optical markers, more particularly, AR codes alongside their orientation, thereby enabling context-based decoding, real-time interaction and data collection and access to augmented reality applications. The invention addresses challenges in accurately measuring rotational angles and aligns the decoded content with real-world orientation. Key features include:
1. Detection of AR Code's Orientation: A detection engine captures and analyses AR codes in real-time, determining their orientation relative to a defined reference (e.g., the horizontal axis of the camera).
2. Use of Rotational Angle to Determine Orientation: A rotational angle is computed by comparing the code's alignment to a normal or horizontal axis. This angle is used to classify or interpret the code in multiple orientation states.
3. Contextual Decoding of AR Code with Orientation Data: The decoded data from the code is passed through an orientation-aware processing module, enabling specific actions or contextual decoding consistent with the code's rotational angle.

By combining these three components in a single workflow, the system can produce dynamic and adaptive responses, enhancing user engagement and improving the accuracy of AR overlays, while also ensuring real-time identification and interaction that eliminates the users' reliance on electronic devices, specialized hardware, and other related limitations, while also supporting orientation or context-based interaction.

The invention describes a real-time response capture system that uses image recognition technology to interpret markers based on their rotational orientation. The system includes four main components: a scanning device for capturing marker images, an orientation detection module that calculates rotation angles relative to a reference point, a decoding module that interprets the marker data considering its orientation to generate contextual outputs, and a data analysis module that processes these outputs into application-specific reports. The markers can be augmented reality (AR) codes that interface with AR applications. These markers may be presented on physical surfaces or electronic displays and can serve as unique user identifiers, allowing the system to associate specific individuals with their responses. The scanning functionality can be implemented across various devices including smartphones, tablets, and AR glasses, providing flexibility in deployment scenarios.

The orientation calculation employs arctangent functions to determine angles between marker corners. The decoding system can access multiple datasets corresponding to different orientation ranges, enabling a single marker to trigger various content outputs depending on its rotational position.

The system incorporates storage capabilities for maintaining marker attributes, orientation data, captured images, and processing outputs from both decoding and analysis modules. The core modules can be integrated into custom mobile applications, potentially developed using ReactNative with C++ programming components.

Furthermore, the present invention discloses a method encompassing marker design and generation, orientation-specific attribute assignment, image capture, orientation detection through rotational angle calculation, marker interpretation via data matching to produce contextual outputs, and output analysis for application-specific reporting.

The interpretation process can retrieve orientation-specific datasets and execute different functions such as content selection, AR overlay display, or feature activation based on detected orientations. The invention can be embodied as executable instructions that perform marker image capture, orientation detection, data interpretation, and output analysis, with additional capabilities for dynamic user interface adaptation when orientation thresholds are crossed.

### BRIEF DESCRIPTION OF THE DRAWINGS

The present invention is described by way of embodiments illustrated in the accompanying drawings wherein:

FIG. 1 is an illustration of an embodiment of the overall system, including the optical marker, a camera or scanning device, an orientation detection module, a decoding module and a data analysis module.

FIG. 2 is an illustration of an alternative embodiment of the system, which in addition to the components of FIG. 1, also includes the storage module.

FIG. 3a is an illustration of an embodiment of the invention for orientation detection of an AR code at various angles to highlight how the system calculates rotational angle relative to the reference axis.

FIG. 3b is an illustration of an embodiment of the invention for orientation-aware differential interpretation by the decoding module of the code basis the rotational angle computed by the orientation detection module.

FIG. 4 is a flowchart which illustrates the method steps of an embodiment of the invention for decoding of rotational angle to yield context-specific output.

FIG. 5 is an embodiment showing the impact of change in orientation on the optical image data.

FIG. 6 is a flowchart which illustrates and embodiment of the method involving the scanning of the optical marker, detecting orientation, decoding, analysis the results to deliver an output corresponding to the orientation.

FIG. 7 is an embodiment of the invention of a practical scenario in which orientation-based decoding is used for the seamless capture of real-time feedback from multiple sources at once.

FIG. 8 highlights the context-specific outputs which may be generated by the decoding module and the data analysis module using the optical marker image data and computed rotational angle.

### DETAILED DESCRIPTION OF THE INVENTION

The following detailed description refers to the accompanying drawings. Wherever possible, the same reference numbers are used in the drawings and the following description to refer to the same or similar parts. While several illustrative embodiments are described herein, modifications, adaptations and other implementations are possible and are covered within the scope of the detailed description. For example, substitutions, additions or modifications may be made to the components illustrated in the drawings, and the illustrative methods described herein may be modified by substituting, reordering, removing, or adding steps to the disclosed methods. Accordingly, the following detailed description is not limiting of the disclosed embodiments. Instead, the proper scope is defined by the appended claims.

Disclosed embodiments provide systems and methods for optical code orientation detection. Specifically, the disclosed systems and methods enable an optical code-enabled feedback system whereby the result of scanning and interpreting an optical code, in particular an AR code would depend upon the detected orientation of the code. The acquisition of images of an optical code may be done through the camera of a mobile device while the optical code itself is displayed on a screen or is printed on paper. For example, a query may be responded to differently by way of a AR code held in distinct orientations, whereas a mobile device is used for reading the AR code displayed and interpreting the response according to the code's detected orientation. Accordingly, the reading of the AR code should result in seamless and real-time collection of feedback data.

As per the invention, described herein is a system for real-time, dynamic response capture comprising: a scanning device configured to capture image data of a marker; an orientation detection module adapted to calculate a rotational angle of said image data of the marker relative to a predefined reference axis; a decoding module, coupled to said orientation detection module, configured to interpret said image data of the marker based at least in part on the image data of the marker and its rotational angle, thereby producing context-specific output; and a data analysis module coupled to the decoding module and configured to collect and analyse outputs received from the decoding module and output a report corresponding to a desired application.

In an embodiment of the invention, the marker includes a AR code and the marker connects to an augmented reality application.

In an embodiment of the invention, the marker is displayed on a physical medium or on an electronic display.

In an embodiment of the invention, the marker uniquely corresponds to a user, and can serve as a unique identifier for said user.

In an embodiment of the invention, the scanning device includes a smartphone, a tablet, and a pair of AR glasses.

In an embodiment of the invention, the mechanism for calculating said rotational angle comprises the calculation of the angle between the corners of the marker using the arctangent function.

In an embodiment of the invention, the decoding module retrieves separate data sets corresponding to different orientation thresholds, allowing a single marker to dynamically trigger multiple content outputs.

In an embodiment of the invention, the system comprises storage module configured to store system attributes/values corresponding to the content of the marker and its rotational angle.

In an embodiment of the invention, the storage module is further configured to store at least one of said image data of the marker and the outputs produced by the decoding module and the data analysis module.

In an embodiment of the invention, the orientation detection module, the decoding module and the data analysis module are implemented within a customized mobile application installed on the scanning device.

In an embodiment of the invention, the customized mobile application is developed with a ReactNative plugin using the C++ programming language.

In an embodiment of the invention, the output produced by the decoding module comprises information relating to the identity of the user presenting the optical marker and said user's response selected from a plurality of responses to a given question.

The present invention is also directed to a method for real-time, dynamic response capture, comprising the steps of designing and generating an optical marker using tools and libraries available in the state of the art; assigning a unique attribute/value to each orientation of the optical marker; capturing image data of the optical marker; detecting the orientation of the optical marker by calculating its rotational angle relative to a predefined reference axis; interpreting said marker by matching the image data of the optical marker and the detected orientation with configuration values/attributes, to produce context-specific output; and collecting and analysing said outputs to produce a report corresponding to a desired application.

In an embodiment of the method of the invention the optical marker includes a AR code and/or the optical marker connects to an augmented reality application.

In an embodiment of the method of the invention the optical marker is displayed on a physical medium or on an electronic display.

In an embodiment of the method of the invention the optical marker uniquely corresponds to a user, and can serve as a unique identifier for said user.

In an embodiment of the method of the invention the step of detecting the orientation of the optical marker comprises the calculation of the angle between the corners of the optical marker using the arctangent function.

In an embodiment of the method of the invention the step of interpreting the optical marker further comprises retrieving separate data sets corresponding to different orientation thresholds, allowing a single marker to dynamically trigger multiple content outputs.

In an embodiment of the method of the invention the step of interpreting the optical marker further comprises selecting different content, displaying distinct AR overlays, or executing different application features based on the detected orientation.

In an embodiment of the method of the invention the, the method further comprises the step of storing system attributes/values corresponding to the image data of the optical marker and its rotational angle.

In an embodiment of the method of the invention the, the method further comprises the step of storing at least one of said image data of the optical marker and the outputs produced by the decoding module and the data analysis module.

In an embodiment of the method of the invention the context-specific output contains information relating to the identity of the user presenting the optical marker and said user's response selected from a plurality of responses to a given question.

The invention is also directed to computer-readable medium containing instructions that, when executed by a processor, cause a system to: capture image data of the optical marker;
detect the orientation of the optical marker by calculating its rotational angle relative to a predefined reference axis; interpret said marker by matching the image data of the optical marker and the detected orientation with configuration values/attributes, to produce context-specific output; and collect and analyse said outputs to produce a report corresponding to a desired application.

The instructions further cause the system to adapt user interface interactions dynamically when the detected orientation crosses an angle threshold.

The embodiments are further explained with the drawings below:

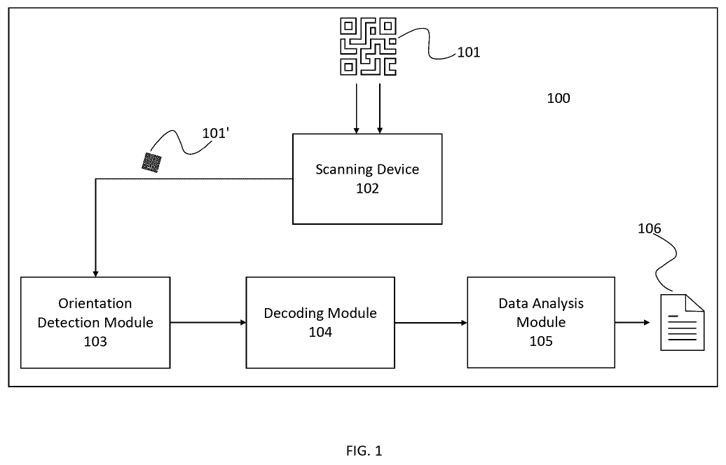

FIG. 1 is an example illustration of an embodiment of the invention, that is a system 100 for orientation detection and contextual decoding of optical/visual markers, consistent with a disclosed embodiment. As shown in system 100, a scanning device 102 is configured to capture an image data of an optical marker 101. The captured image data 101′ is then used by the orientation detection module 103 to calculate the rotational angle of the image data of the optical marker, which image data and/or rotational angle are used by the decoding module 104 to produce context-specific output, which is then used by a data analysis module 105 to analyse the output of the decoding module 104 and output a report 106 corresponding to a desired application.

One of skill in the art will appreciate that although one each of the various modules are depicted in FIG. 1, any number of these components may be provided. Furthermore, one of ordinary skill in the art will recognize that one or more components of system 100 may be combined and/or divided into subcomponents.

The optical marker 101 comprises AR Code with features which permit the re-alignment of the optical code. AR codes each use three positional markers also known as finder patterns. The optical marker may be capable of encoding one or multiple kinds of information. In a preferred embodiment, the optical marker 101 is a AR code. In an embodiment, a AR code connects to an augmented reality application.

The optical marker 101 may have multiple distinct orientations within the 2-dimensional coordinate space or the cartesian plane comprising of the x (horizontal) and y (normal) axes. Each of the multiple orientations of the optical marker may correspond to a system value/attribute, with each orientation determined through being mapped to specific rotational angle thresholds. In a preferred embodiment, the four orientations of a AR code, one each corresponding to each side of the square-shaped optical marker, may correspond to distinct thresholds/ranges for the rotational angle computed by the orientation detection module 103. Further, the optical marker 101 may also encode unique identification information relating to the user. Thus, the processing of the optical marker image data 101′ may provide orientation-aware feedback as well as information about the source of said feedback.

Furthermore, the optical marker 101 may be displayed on the screen of an electronic device, such as a smartphone or tablet, or printed on any physical medium such as paper or cardboard. In a preferred embodiment, the optical marker 101 may be printed on paper, permitting the use of the AR code to convey information even without the availability of an electronic device with a screen.

The scanning device 102 may include any known camera hardware and/or software that can be implemented with a mobile device or otherwise. The scanning device 102 may be a smartphone or tablet equipped with a camera, a handheld camera, an augmented reality scanner, a wearable device with a camera or an imaging or scanning module, a pair of augmented reality glasses or any other imaging device capable of capturing image data of the optical/visual marker. The scanning device 102 may include an image sensor for converting an optical image into an electrical signal. In some embodiments, the scanning device 102 may comprise more than one camera (e.g., front and rear facing cameras on a smartphone). Elements and operations of the scanning device 102 may be software-based and/or hardware-based. The image data captured may or may not be stored in a storage module or in system memory. In an embodiment, the captured image data 101′ may be processed on-the-fly for the computation of rotational angle and extraction of identity data without such image data being stored in the storage module or in system memory. In an alternative embodiment, the image data 101′ may be stored in the system memory or in the storage module.

The system 100, including the orientation detection module 103, the decoding module 104 and the data analysis module 105, may be implemented using software or hardware elements or a combination or both.

Hardware components of the system 100 may include a processor comprising of one or more known processing devices, such as a microprocessor. One of ordinary skill in the art would understand that there may be several types of processors and processor arrangements with varying capacities which could be implemented to provide the capabilities disclosed herein. Hardware components of the system 100 may further include a memory comprising a tangible and non-transitory computer-readable medium having stored therein computer programs, sets of instructions, code, or data to be executed by the processor. The memory may comprise one or more memory devices that store data including, but not limited to, random access memory (RAM), read-only memory (ROM), a magnetic storage device (e.g., a hard disk), an optical storage medium (e.g., a CD- or DVD-ROM), a high-definition optical storage medium, an electronic storage device (e.g., EPROM or a flash drive), and/or another other data storage devices known in the art. Hardware elements may further include a display screen appropriate for a mobile device or a larger standalone display screen. In all cases, the some or all components of the system 100 may be implemented on an integrated hardware platform or over a network, such that the any of the components may communicate with and transmit information to and from any of the other components of the system 100 over such network using any wired or wireless communication protocols existing in the art. The hardware component may also include, the scanning device 102 may include any known camera hardware and software that can be implemented with a mobile device or otherwise. The scanning device 102 may be a smartphone or tablet equipped with a camera, a handheld camera, an augmented reality scanner, a wearable device with a camera or an imaging or scanning module, a pair of augmented reality glasses or any other imaging device capable of capturing image data of the optical/visual marker.

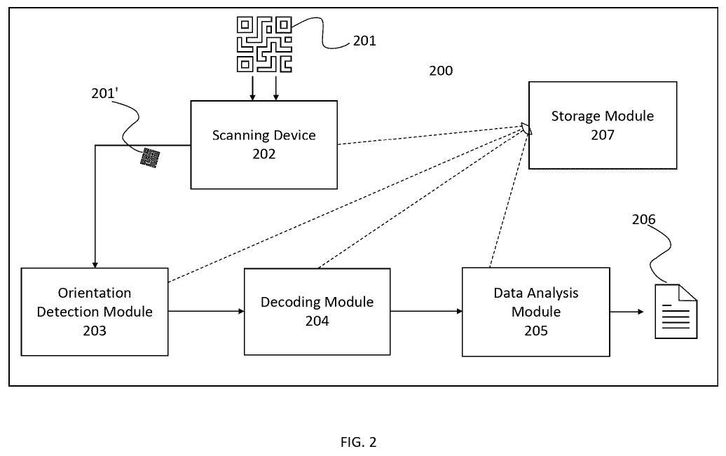

FIG. 2 is an alternate embodiment illustration of a system disclosed in the invention. The system 200 also performs orientation detection and contextual decoding of optical/visual markers, consistent with a disclosed embodiment, in a manner similar to 100, with the addition of a storage module 207 which is configured to store system attributes/values corresponding to the content of the marker and its rotational angle used by the decoding module to return a context-specific output. In a preferred embodiment, the storage module 207 is also configured to store the captured image data of the optical marker and/or the outputs produced by the decoding module and/or the data analysis module.

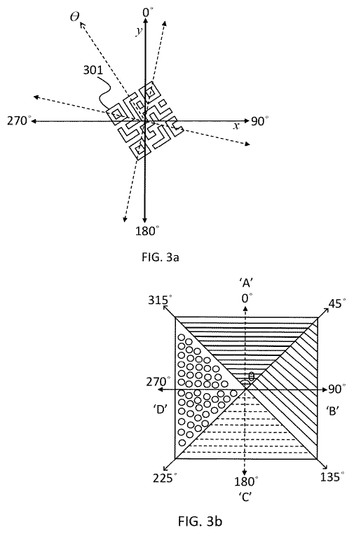

FIG. 3a illustrates the computation by the orientation detection module 103 of a rotational angle associated with the image data 101′ of the optical marker as captured by the scanning device 102. The orientation detection module 103 computes a rotational angle for the image data 101′ by comparing its alignment with a reference normal or horizontal axis. In an embodiment, the mechanism for calculating said rotational angle comprises the calculation of the angle between the top-right and top-left corners of the optical marker using the arctangent function. For example, FIG. 3a, shows the computation of the rotational angle ‘θ’ for the optical marker, 301, calculated basis the angle between the corners of the optical marker.

FIG. 3b illustrates the rotational angle thresholds used by the decoding module 104 for the interpretation of the rotational angle and orientation of the square-shaped AR code. FIG. 3b indicates the correlation between the detected orientation and the interpretation corresponding thereto. Therefore, if the value of θ were to fall within the range of 316° and 45°, the orientation of the AR code would be interpreted as being ‘A’. If, on the other hand, the value of θ were to fall within the range of 136° and 225°, the orientation of the AR code would be interpreted as being ‘C’. The differential interpretation of the AR code basis its orientation may be used to dynamically trigger multiple content outputs.

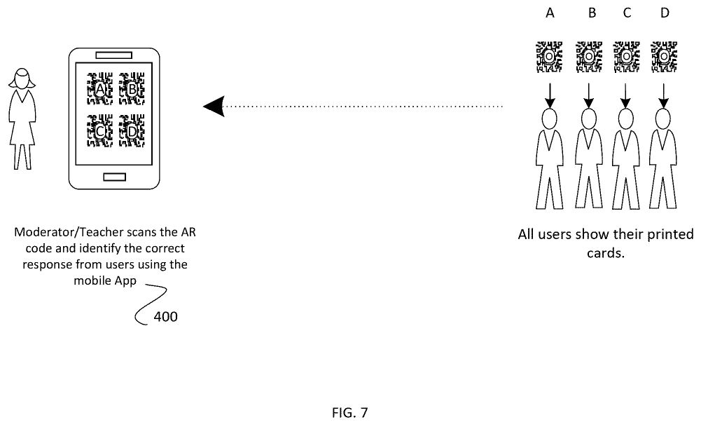

In a preferred embodiment, the systems 100 and 200 may be implemented by way of a customized mobile software, i.e. a mobile app, installed on a smartphone, tablet, wearable device, AR-enabled glasses or other such electronic device. FIG. 7 shows a mobile app which may be used to capture image data through the scanning device or camera of the mobile device. The systems 100 and 200 may be implemented using both the software components forming part of the electronic device and the mobile app as well as the various hardware components such as the camera, processor, memory, display etc. forming part of the electronic mobile device on which said app is installed. In a preferred embodiment, the customized mobile app may be developed with a ReactNative plugin using the C++ programming language. The ReactNative plugin enables the mobile app to capture the optical marker image data using the mobile device's camera, and detect the optical marker's orientation.

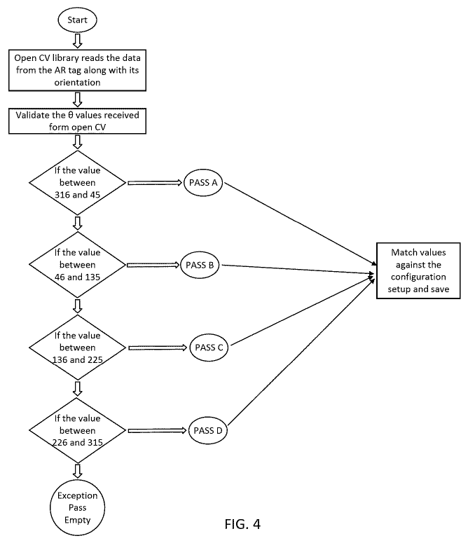

FIG. 4 is a flowchart which illustrates an example of the steps of orientation-aware interpretation in the method disclosed herein. In a preferred embodiment, the mobile app may be built with ReactNative for its UI, using the C++ programming language and the OpenCV libraries, enabling the mobile app to capture and process the optical marker image data and detect its orientation. The orientation represented through the rotational angle value may be mapped to rotational angle thresholds in the cartesian plane, whereby a rotational angle value θ between 316° and 45° would output ‘A’, between 46° and 135° would output ‘B’, between 136° and 225° would output ‘C’ and between 226° and 315° would output ‘D’. The output received would be matched against the stored system value/attributes to return a context-specific response.

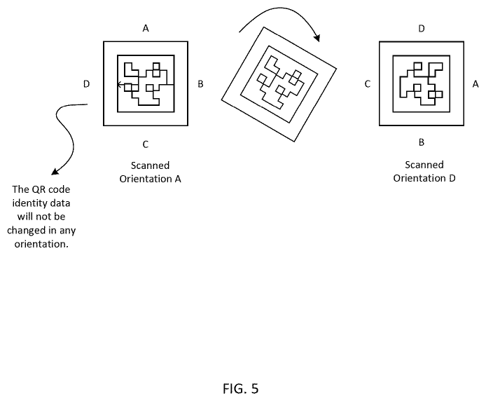

FIG. 5 demonstrates that while the orientation of the AR code as presented may have an effect on the interpretation of the AR code, the identity data encoded within a AR code does not undergo any change and is orientation-agnostic.

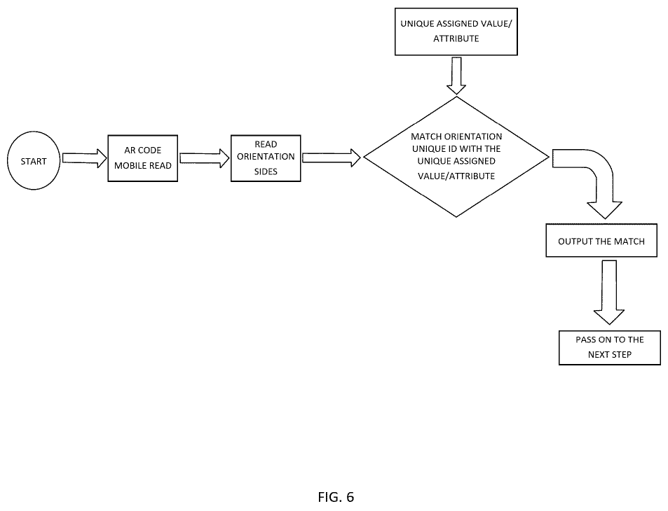

FIG. 6 is a flowchart indicating the series of steps involved in the method of orientation detection and contextual decoding of optical/visual marker disclosed herein. In an embodiment, the method may involve the steps of the optical marker being read using the scanning device such as a mobile camera and the mobile app, the orientation of the optical marker being detected by the orientation detection module, the unique ID assigned to the detected orientation being mapped by the decoding module to the stored system value/attributes stored in a storage module, and upon a match, a context-specific output being passed on to the next step which involves analysis of the output by the data analysis module.

A method for real-time, dynamic response capture, comprising the steps of designing and generating an optical marker using tools and libraries available in the state of the art, assigning a unique attribute/value to each orientation of the optical marker, capturing image data of the optical marker, detecting the orientation of the optical marker by calculating its rotational angle relative to a predefined reference axis, interpreting said optical marker by matching the image data of the optical marker and the detected orientation with configuration values/attributes, to produce context-specific output and collecting and analyzing said outputs to produce a report corresponding to a desired application is also disclosed, along with its embodiments aligned with the embodiments of the system disclosed herein.

A person with ordinary skill in the art would appreciate that the steps of optical marker generation may be performed by the same custom mobile app which may implement the remaining steps of capturing image data, orientation detection and producing a context-specific output.

Further, a computer-readable medium containing instructions that, when executed by a processor, cause a system to function in the manner disclosed herein is also disclosed. In a preferred embodiment of the disclosed computer readable medium, the instructions further cause the system to adapt user interface interactions dynamically when the detected orientation crosses an angle threshold.

In FIG. 7, an exemplary embodiment showing the implementation of the system and method disclosed in the present invention is demonstrated. The mobile device and app may be used for capturing the optical marker image data from one or many respondents within the same frame and image data 101′, 201′ for each optical marker be processed separately to extract identity information as well as to detect orientation thereof. In this exemplary embodiment, image data is captured simultaneously for respondents A, B, C and D. The orientation for the optical marker presented by each of the respondents is mapped to the system values/attributes and a context specific response is returned as output. For instance, for A, B and C, the AR code presented is recognized as ‘green’, whereas for D the AR code presented is recognized as ‘red’. This information may be collected and analyzed to produce a report on the performance and responses of the group of respondents.

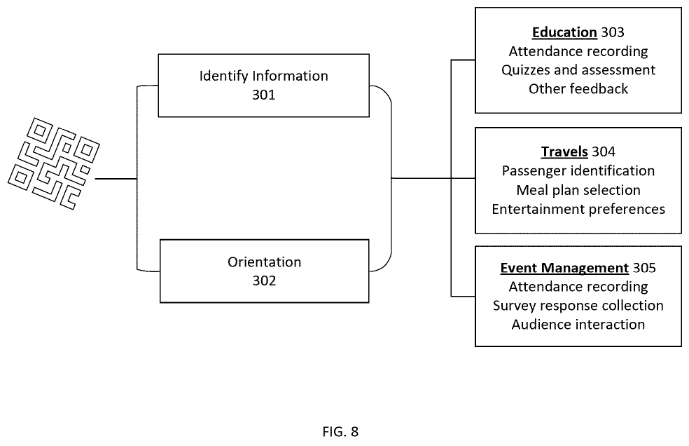

FIG. 8 illustrates the various embodiments of the system and method of the invention in the domains of education, travel management and event management. In an embodiment, a tutor may use the disclosed system and method to provide each student of the class a unique AR code mapped to his or her identity. The AR cades may be provided printed on sheets of paper or cardboard. The tutor may pose multiple-choice questions and quiz a group of students at once, answers to which may be collected basis the orientation of the AR code as presented. For instance, Student 1 may present his AR code in an orientation which corresponds to option C, whereas Student 2 may simultaneously present his AR code in a different orientation to reflect his choice of answer, say option A. The image data for both AR codes may be processed to extract the identities of the students who have presented their AR codes, and the associated rotational angle for their respective image data may be computed to ascertain the answers given by those particular students. Moreover, since the collection of data is on a real-time and automated basis, the students' performance may be tracked over a period of time. Further, reports may be generated to show class performance, by utilizing the collected data for multiple or all students over a period of time or in any particular test. Thus, the instant system and method may be used for student performance assessment and tracking.

In another embodiment, the disclosed system and method may be used in the field of travel to capture meal preferences—vegetarian, non-vegetarian, Asian, Jain etc. in the course of travel, for instance aboard aircrafts, for each passenger on-board identified through their unique QR codes presented in orientations corresponding to their meal choices. Similarly, choices for entertainment may be captured.

In another exemplary embodiment, the disclosed system and method may be used in the field of event management, for instance for recording attendance at a marge event, for collection of survey responses, anonymized or otherwise, for the collection of bids during an auction where the identity of the bidder may also be recorded along with, and for the purpose of audience interaction, whereby audience members indicate their feedback by way of AR codes presented in a specific orientation.

The invention provides a comprehensive approach to marker-based data retrieval, incorporating orientation detection to enable context-sensitive decoding and user experiences. The user can be any individual, using the AR marker, a student, a traveler or any other individual. By determining the rotational angle of a code and adjusting the decoded output accordingly, a single code can support multiple functionalities while aligning virtual overlays more accurately in real-world spaces. A person with ordinary skill in the art would be able to apply the presently disclosed system and method to other exemplary embodiments including in the fields of sports, logistics, etc.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. For example, the described implementations may include software, but systems and methods consistent with the disclosed embodiments may be implemented as a combination of hardware and software, or in hardware alone. Examples of hardware include computing or processing systems, including personal computers, servers, laptops, mainframes, micro-processors and the like. Additionally, although aspects of the disclosed embodiments are described as being stored in memory, one skilled in the art will appreciate that these aspects can also be stored on other types of computer readable media, such as secondary storage devices, for example, hard disks, floppy disks, or CD ROM, or other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. One or more of such software sections or modules can be integrated into a computer system or existing e-mail or browser software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

We claim:

1. A system for real-time, dynamic response capture comprising
a scanning device configured to capture image data of a marker;
an orientation detection module adapted to calculate a rotational angle of said image data of the marker relative to a predefined reference axis;
a decoding module, coupled to said orientation detection module, configured to interpret said image data of the marker based at least in part on the image data of the marker and its rotational angle, thereby producing context-specific output; and
a data analysis module coupled to the decoding module and configured to collect and analyse outputs received from the decoding module and output a report corresponding to a desired application.

2. The system as claimed in claim 1, wherein the marker includes a AR code.

3. The system as claimed in claim 1, wherein the marker connects to an augmented reality application.

4. The system as claimed in claim 1, wherein the marker is displayed on a physical medium or on an electronic display.

5. The system as claimed in claim 1, wherein the marker uniquely corresponds to a user, and can serve as a unique identifier for said user.

6. The system as claimed in claim 1, wherein the scanning device includes a smartphone, a tablet, and a pair of AR glasses.

7. The system as claimed in claim 1, wherein the mechanism for calculating said rotational angle comprises the calculation of the angle between the corners of the marker using the arctangent function.

8. The system as claimed in claim 1, wherein the decoding module retrieves separate data sets corresponding to different orientation thresholds, allowing a single marker to dynamically trigger multiple content outputs.

9. The system as claimed in claim 1, further comprising a storage module configured to store system attributes/values corresponding to the content of the marker and its rotational angle.

10. The system as claimed in claim 9, wherein the storage module is further configured to store at least one of said image data of the marker and the outputs produced by the decoding module and the data analysis module.

11. The system as claimed in claim 1, wherein the orientation detection module, the decoding module and the data analysis module are implemented within a customized mobile application installed on the scanning device.

12. The system as claimed in claim 11, wherein the customized mobile application is developed with a ReactNative plugin using the C++ programming language.

13. The system as claimed in claim 1, wherein the output produced by the decoding module comprises information relating to the identity of the user presenting the optical marker and said user's response selected from a plurality of responses to a given question.

14. A method for real-time, dynamic response capture, comprising the steps of
designing and generating an optical marker using tools and libraries available in the state of the art;
assigning a unique attribute/value to each orientation of the optical marker;
capturing image data of the optical marker;
detecting the orientation of the optical marker by calculating its rotational angle relative to a predefined reference axis;
interpreting said marker by matching the image data of the optical marker and the detected orientation with configuration values/attributes, to produce context-specific output; and
collecting and analysing said outputs to produce a report corresponding to a desired application.

15. The method claimed in claim 14, wherein the optical marker includes a AR code.

16. The method claimed in claim 14, wherein the optical marker connects to an augmented reality application.

17. The method as claimed in claim 14, wherein the optical marker is displayed on a physical medium or on an electronic display.

18. The method as claimed in claim 14, wherein the optical marker uniquely corresponds to a user, and can serve as a unique identifier for said user.

19. The method as claimed in claim 14, wherein the step of detecting the orientation of the optical marker comprises the calculation of the angle between the corners of the optical marker using the arctangent function.

20. The method as claimed in claim 14, wherein the step of interpreting the optical marker further comprises retrieving separate data sets corresponding to different orientation thresholds, allowing a single marker to dynamically trigger multiple content outputs.

21. The method as claimed in claim 20, wherein the step of interpreting the optical marker further comprises selecting different content, displaying distinct AR overlays, or executing different application features based on the detected orientation.

22. The method as claimed in claim 14, further comprising the step of storing system attributes/values corresponding to the image data of the optical marker and its rotational angle.

23. The method as claimed in claim 22, further comprising the step of storing at least one of said image data of the optical marker and the outputs produced by the decoding module and the data analysis module.

24. The method as claimed in claim 14, wherein the context-specific output contains information relating to the identity of the user presenting the optical marker and said user's response selected from a plurality of responses to a given question.

25. A computer-readable medium containing instructions that, when executed by a processor, cause a system to:
capture image data of the optical marker;
detect the orientation of the optical marker by calculating its rotational angle relative to a predefined reference axis;
interpret said marker by matching the image data of the optical marker and the detected orientation with configuration values/attributes, to produce context-specific output; and
collect and analyse said outputs to produce a report corresponding to a desired application.

26. The computer readable medium of claim 25, wherein the instructions further cause the system to adapt user interface interactions dynamically when the detected orientation crosses an angle threshold.

27. The system as claimed in claims 6, wherein the orientation detection module, the decoding module and the data analysis module are implemented within a customized mobile application installed on the scanning device.
